(19) United States
(12) Patent Application Publication
(10) Pub. No.: US 2026/0008261 A1
(43) Pub. Date: Jan. 8, 2026

(54) METHOD TO PRODUCE A SUBSTRATE WITH A FOAM LAYER AND SUCH A BUILDING PANEL

(71) Applicant: Välinge Innovation AB, Viken (SE)

(72) Inventors: Pontus GAMSTEDT, KATTARP (SE); Filip SKÖLD, LÖDDEKÖPINGE (SE)

(73) Assignee: Välinge Innovation AB, Viken (SE)

(21) Appl. No.: 19/257,703

(22) Filed: Jul. 2, 2025

(30) Foreign Application Priority Data
Jul. 3, 2024 (SE) 2450753-5

(51) Int. Cl. B32B 37/15; B32B 7/10; B32B 27/06; B32B 27/08; B32B 27/30; B32B 27/32; B32B 37/00; B32B 37/10

(52) U.S. Cl. CPC B32B 37/153; B32B 7/10; B32B 27/065; B32B 27/08; B32B 27/304; B32B 27/32; B32B 37/10; B32B 2037/0092; B32B 2250/02; B32B 2250/246; B32B 2255/26; B32B 2266/0235; B32B 2266/025; B32B 2307/72; B32B 2307/7376; B32B 2607/00

(57) ABSTRACT

The present disclosure relates to a method to produce a substrate (2) provided with a foam layer (3). The method comprises extruding a substrate (2) comprising a thermoplastic polymer, applying a foam layer (3) having a foamed structure and comprising a thermoplastic polymer on a first surface (2a) of the substrate (2) after the substrate (2) has been extruded, wherein the foam layer (3) is adhered to the substrate (2) at least partly by heat from the extruded substrate (2). The disclosure also relates to such a substrate (2) with the integrated foam layer (3), and a building panel comprising the substrate (2) provided with the foam layer (3).

### CROSS REFERENCE TO RELATED APPLICATIONS

The present application claims the benefit of Swedish Application No. 2450753-5, filed on Jul. 3, 2024. The entire contents of Swedish Application No. 2450753-5 are hereby incorporated herein by reference in their entirety.

### TECHNICAL FIELD

The present disclosure relates to a method to produce a substrate provided with a foam layer, such as an integrated foam layer. The substrate with the foam layer may form, or form part of, a board, a substrate element, or a panel, configured for flooring. The method may consequently be directed to producing a board, a substrate element, or a panel, configured for flooring. The disclosure also relates to a building panel, such as a floor panel, including such substrate with the foam layer. The foam layer may function as an underlay configured to face a sub-structure, such as a sub-floor or any other type of sub-surface.

### TECHNICAL BACKGROUND

For floorings, it is conventional to arrange an underlay, such as a foam layer, between the floor covering and a sub-floor. The underlay may compensate for any unevenness of the sub-floor and may, for example, reduce the risk of damaging components of the floor covering, such as floor panels. Moreover, the underlay may improve the characteristics of the floor covering, such as its comfort and/or sound properties, e.g., the reflective walking sound and/or impact sound. In some configurations, the underlay may function as a moisture barrier.

Currently commercially available underlays for flooring are focused to be cost effective and easy produced, yet still have the abilities of absorb unevenness's and still provide sound reduction. Common materials used are IXPE, EVA, XPS or more high-end PET and XPO type of underlays. All types of underlays compress over time which may result in that the support of the underlay ceases to be sufficient.

Underlays may be loose, such as being loosely arranged on the sub-floor prior to installing the floor covering on the underlay. The underlay, for example in form of a plurality of individual underlay elements, is positioned on the sub-floor and adjusted to the shape of the room. Thereafter, the floor covering is installed on the loosely arranged underlay elements.

In an alternative to loose underlay elements, the panels, for example floor panels, are provided with an underlay material on the surface configured to face the sub-floor. The underlay material is glued to the lower surface of the floor panel by an adhesive. Gluing an underlay material to the floor panels involves an extra step in the manufacturing process.

### SUMMARY

An object of at least examples of the present disclosure is to provide an improved method to produce a substrate provided with a foam layer and an improved building panel, such as a floor panel, comprising such substrate with the foam layer.

An object of at least examples of the present disclosure is to provide an improved method to produce a panel for flooring, or a substrate element for flooring, comprising such substrate provided with the foam layer.

According a first aspect of the disclosure, a method to produce a substrate provided with a foam layer is provided. The method comprises:
extruding, in an extrusion process, a substrate comprising a thermoplastic polymer,
applying a foam layer on a first surface of the substrate after the substrate has been extruded, the foam layer having a foamed structure and comprising a thermoplastic polymer,
wherein the foam layer is adhered to the substrate at least partly by heat from the extruded substrate, wherein the heat from the extruded substrate originates from the extrusion process.

The foam layer may be bonded to the substrate at least partly by heat from the extruded substrate, wherein the heat from the extruded substrate originates from the extrusion process.

The adherence of the foam layer to the substrate may provide sufficient bonding between the foam layer and the substrate to allow the substrate to be handled, without the foam layer falling off the substrate.

The adherence of the foam layer to the substrate may provide sufficient bonding between the foam layer and the substrate, such that the bonding strength exceeds the force of gravity, when a surface of the foam layer not being adhered to the substrate is facing downwards. Thereby, the foam layer is adhered to the substrate such the substrate can be turned upside down, without the foam layer falls off the substrate.

The foam layer may be configured to replace a conventional underlay, which conventionally may be glued to a substrate, or be loosely arranged on a sub-structure prior to installing a building panel. The present disclosure relates to a substrate provided with an integrated foam layer, such that the substrate and the foam layer can be handled as one unit.

The substrate may be provided with the foam layer in a process integrated with the production process of the substrate. Additional layers may be applied to the substrate in the process, such that the process is directed to a method to provide a building panel, or a substrate element, comprising the substrate provided with the foam layer. As an alternative, additional layers may be applied in a subsequent process.

The substrate may have a density of 800-2200 kg/m³.

A density of the foam layer may be less than the density of the substrate.

The substrate may be configured to form, or form part of a board, a substrate element, or a panel, configured for flooring. Thereby, in an example of the first aspect, the method may be directed to produce a board, a substrate element, or a panel, configured for flooring.

The flooring may be configured for a floating installation.

In an example of the first aspect, the method may be directed to produce a building panel, such as a floor panel, comprising the substrate provided with the foam layer.

In an example of the first aspect, the method may be directed to produce a substrate element, such as a floor substrate element, comprising the substrate provided with the foam layer.

In an example of the first aspect, the method may be directed to produce a board, such as a floor board, comprising the substrate provided with the foam layer.

The method may further comprise applying a surface layer on a second surface of the substrate, opposite the foam layer, wherein the surface layer comprises a decorative layer.

A thickness of the foam layer may be less than a thickness of the substrate.

The substrate may have a thickness of 3-12 mm, such as 4-8 mm.

The foam layer may have a thickness of 0.25-5 mm, such as 0.5-3 mm.

The foam layer may have a thickness of 0.25-3 mm.

The substrate may have a thickness exceeding 3 mm.

The foam layer may have a thickness being less than 3 mm.

The thermoplastic polymer of the foam layer and the thermoplastic polymer of the substrate may be of the same type of thermoplastic polymer. By same type of thermoplastic polymer is considered thermoplastic polymers comprising the same monomer. In case of co-polymers, at least 50% of the thermoplastic co-polymer comprises the same monomer as the other thermoplastic polymer, or co-polymer. In other examples, the co-polymer may comprise at least 75% such as at least 90% of the same monomer as the other thermoplastic polymer, or co-polymer.

The thermoplastic polymer of the foam layer and the thermoplastic polymer of the substrate may comprise the same monomer.

In case of co-polymers, at least 50% of the thermoplastic co-polymer comprises the same monomer as the other thermoplastic polymer, or co-polymer. In other examples, the co-polymer may comprise at least 75% such as at least 90% of the same monomer as the other thermoplastic polymer, or co-polymer.

Thereby, recycling of the substrate may be facilitated as the foam layer does not have to be divided from the substrate prior to recycling. Further, bonding strength between the substrate and the foam layer may be improved by the use of the same type of thermoplastic polymer in the substrate and in the foam layer.

The foam layer may be applied subsequent to the extrusion process of the substrate. Thereby, heat from extrusion process may be used to adhere the foam layer to the substrate.

The foam layer may be recycled with the substrate, as the foam layer and the substrate may comprise the same type of thermoplastic polymer.

No adhesive may be applied to adhere the foam layer to the substrate. No separate adhesive may be added to adhere the foam layer to the substrate.

The foam layer may be provided as a film. The foam layer may not be extruded, or co-extruded, with the substrate.

The foam layer may be applied on the first surface of the substrate prior to cooling the substrate after extruding.

The foam layer may be applied on the first surface of the substrate prior to active cooling the substrate after extruding.

The foam layer may be applied on the first surface of the substrate prior to active cooling the substrate after extruding, such as cooling in a cooling zone. By cooling may include cooling in a temperature below ambient temperature, i.e. below 20° C.

The foam layer may be applied on the first surface of the substrate when the first surface of the substrate has a temperature of 120-240° C. after extrusion, such as 130-230° C. for example 140-220° C.

In another example, the foam layer may be applied on the first surface of the substrate when the first surface of the substrate has a temperature of 80-240° C. after extrusion, such as 80-160° C.

In one example, no heat may be added when adhering the foam layer to the first surface of the substrate.

In one example, no heat may be added after the extrusion process for adhering the foam layer to the first surface of the substrate.

In one example, no heat may be added to the substrate or the foam layer for adhering the foam layer to the first surface of the substrate.

In one example, the only heat for adhering the foam layer to the substrate may be the heat from the extrusion process.

In another example, heat may be added when adhering the foam layer to the first surface of the substrate. In one example, the method may include pre-heating the foam layer to adhere to the substrate.

The foam layer may be applied to the first surface of the substrate within 10 minutes after the substrate has left the die of the extrusion process.

Thereby, the foam layer may be applied to the substrate in conjunction with the extrusion process.

The substrate may be unfoamed.

The substrate may be a rigid substrate.

The foam layer may be provided as a film.

The foam layer may not be extruded, such as not being co-extruded with the substrate.

The foam layer may not be applied as a plastisol.

The foam layer may comprise an open cell or closed cell structure.

The foam layer may have a density being less than a density of the substrate.

The foam layer may have a density beingless than 700 kg/m³, such as less than 500 kg/m³.

The foam layer may be adhered to the substrate as a continuous sheet.

The substrate may be in continuous form when the foam layer is adhered to the substrate.

The foam layer may be laminated to the substrate.

The foam layer may be applied to the substrate by pressing rollers.

The foam layer may be applied to the substrate by pressing plates.

The thermoplastic polymer of the substrate and of the foam layer may be polyvinyl chloride (PVC), or a co-polymer thereof.

The thermoplastic polymer of the substrate and of the foam layer may be polypropylene (PP), or a co-polymer thereof.

The substrate may comprise at least one filler.

The foam layer may have a compressive strength about 50-900 kPa (at 0.5 mm) as measured in accordance with EN16354:2018, such as 100-600 kPa (at 0.5 mm) as measured in accordance with EN16354:2018.

The method may further comprise applying the surface layer by pressing rollers.

The decorative layer may be a printed polymeric film.

Applying the surface layer on the second surface of the substrate, opposite the foam layer, wherein the surface layer comprises the decorative layer, may comprise digitally printing a print on the second surface of the substrate.

Applying the surface layer on the second surface of the substrate, opposite the foam layer, wherein the surface layer comprises the decorative layer, may comprise digitally printing a print a print layer configured to be arranged on the second surface of the substrate.

The decorative layer may be a print provided the second surface of the substrate, or may be a print provided on a print layer.

The surface layer may further comprise a wear layer.

The method may further comprise dividing the substrate element, such as the substrate element for flooring, into building panels, such as floor panels.

The adherence of the foam layer to the substrate may be graded as at least “Good bond” in accordance with the scale described below under heading “Examples”.

According to a second aspect of the disclosure, a building panel, such as a floor panel, is provided. The building panel, such as the floor panel, comprises:
an extruded substrate comprising a thermoplastic polymer,
a foam layer having a foamed structure and comprising a thermoplastic polymer, wherein the foamed layer is adhered to a first surface of the substrate without any adhesive.

The thermoplastic polymer of the foam layer and the thermoplastic polymer of the substrate may comprise the same monomer.

In case of co-polymers, at least 50% of the thermoplastic co-polymer comprises the same monomer as the other thermoplastic polymer, or co-polymer. In other examples, the co-polymer may comprise at least 75% such as at least 90% of the same monomer as the other thermoplastic polymer, or co-polymer.

The foam layer may be bonded to the first surface of the substrate.

The adherence of the foam layer to the substrate may provide sufficient bonding between the foam layer and the substrate to allow the building panel to be handled, without the foam layer falling off the substrate.

The adherence of the foam layer to the substrate may provide sufficient bonding between the foam layer and the substrate, such that the bonding strength exceeds the force of gravity, when a surface of the foam layer not being adhered to the substrate is facing downwards. Thereby, the foam layer is adhered to the substrate such the building panel can be turned upside down, without the foam layer falls off the substrate.

The substrate may have a density of 800-2200 kg/m³.

A density of the foam layer may be less than the density of the substrate.

The building panel, such as the floor panel, may further comprise a surface layer on a second surface of the substrate, opposite the foam layer, wherein the surface layer comprises a decorative layer.

A thickness of the foam layer may be less than a thickness of the substrate.

The substrate may have a thickness of 3-12 mm, such as 4-8 mm.

The foam layer may have a thickness of 0.25-5 mm, such as 0.5-3 mm.

The foam layer may have a thickness of 0.25-3 mm.

The substrate may have a thickness exceeding 3 mm.

The foam layer may have a thickness being less than 3 mm.

The foam layer may be adhered to the first surface of the substrate as a sheet.

The foam layer may not be adhered to the first surface of the substrate as a plastisol.

A density of the foam layer may be less than a density of the extruded substrate.

The foam layer may have a density being less than 700 kg/m³, such as less than 500 kg/m³.

The thermoplastic polymer of the substrate and of the foam layer may be polyvinyl chloride (PVC), or a co-polymer thereof.

The thermoplastic polymer of the substrate and of the foam layer may be polypropylene (PP), or a co-polymer thereof.

The substrate may comprise at least one filler.

The substrate may be a rigid substrate.

The substrate may be unfoamed.

The foam layer may not be extruded, or co-extruded, with the substrate.

The foam layer may not be a plastisol.

The foam layer may have a compressive strength about 50-900 kPa (at 0.5 mm) as measured in accordance with EN16354:2018, such as 100-600 kPa (at 0.5 mm) as measured in accordance with EN16354:2018.

The foam layer may comprise a moisture barrier.

The decorative layer may be a printed polymeric film.

The decorative layer may be a digital print provided on the second surface of the substrate.

The surface layer may further comprise a wear layer.

The building panel may be provided with a mechanical locking system for joining an edge of the panel to an edge of an adjacent panel.

The mechanical locking system may be at least partially formed in the substrate.

### BRIEF DESCRIPTION OF THE DRAWINGS

The present disclosure will by way of example be described in more detail with reference to the appended schematic drawings, which show examples of the present disclosure.

FIG. 1 shows a method to produce a building panel, such as a floor panel, comprising a substrate according to a first example.

FIG. 2 shows a method to apply a surface layer on the substrate.

FIG. 3 shows a method to produce a building panel, such as a floor panel, comprising a substrate according to a second example.

FIG. 4 shows a method to produce a building panel, such as a floor panel, comprising a substrate according to a third example.

FIG. 5 shows a method to produce a substrate according to a fourth example.

FIG. 6A shows a perspective view of a building panel, such as a floor panel, including a substrate.

FIG. 6B shows a cross-sectional view of the building panel in FIG. 5A.

FIG. 6C shows a cross-sectional view of an alternative building panel.

### DETAILED DESCRIPTION

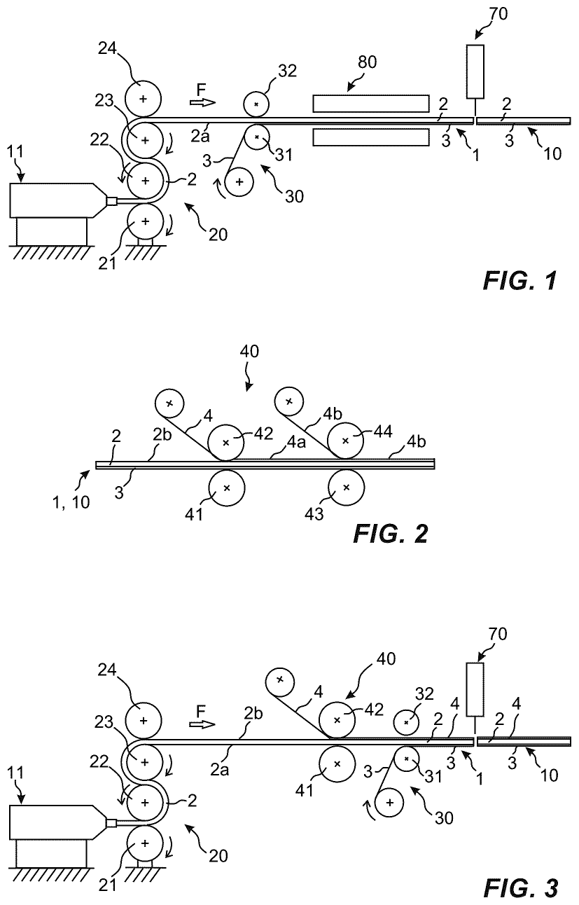

FIG. 1 shows an example of a method to produce a substrate 2 provided with a foam layer 3. The substrate 2 may be, or be configured to form part, of a building panel, such as a floor panel, a wall panel, a furniture component, a building component, a worktop, etc. The method may be an example of a Solid Polymer Core (SPC) process, also known as a Stone Polymer (Plastic) Composite (SPC). The substrate may be a Solid Polymer Core (SPC) substrate, also known as a Stone Polymer (Plastic) Composite (SPC).

The substrate 2 provided with the foam layer 3 may form, or form part of, a substrate element 10, for example, a building element, such as a floor element.

The method may be directed to form a board 1 configured for flooring, a substrate element 10 configured for flooring, or a panel 100 configured for flooring, depending on the size of produced product.

The method comprises extruding the substrate 2 through a die of an extruder 11. The substrate 2 may be extruded as one layer, or may comprise one or more extruded substrate layers forming the substrate 2.

The substrate 2 is extruded in an extrusion process.

The extruder 11 may be a twin screw extruder. Other any other type of extruder may be used, such as a two-step extruder, kneader, continuous mixer, planetary roller extruder, etc. The extruder may comprise a die, through which the material leaves the extruder.

The substrate 2 comprises a polymer material, such as a thermoplastic polymer material. The thermoplastic polymer material may comprise thermoplastic polymers, such as polyvinyl chloride (PVC), polypropylene (PP), polyethylene (PE), polyethylene terephthalate (PET), or a combination thereof.

In one example, the polymer material of the substrate 2 is not polyethylene (PE).

The substrate 2 may comprise the thermoplastic polymer material in an amount of 10-40 wt %, such as 15-35 wt %. The substrate 2 may further comprise at least one inorganic or organic filler, preferably in an amount exceeding 40 wt %, more preferably exceeding 60 wt %, such as 50-90 wt % or 60-80 wt %. For example, the inorganic filler may be a mineral material, for example CaCO₃, talc, fly ash, or a stone material, such as stone powder. Examples of CaCO₃ may be marble, limestone or chalk. The organic filler may be a wood material, a bamboo material, cork husks, or rice husks. For example, the wood material may be wood fibres, wood flour and/or wood dust, and the bamboo material may be bamboo dust.

A density of the substrate 2 may be 800-2200 kg/m³. The substrate 2 may have a thickness of 2-18 mm, such as 3-12 mm, preferably 4-8 mm.

The thickness may be measured in a direction perpendicular to a plane formed by a first surface 2a of the substrate 2.

The substrate 2 may be a rigid substrate, such as a Solid Polymer Core (SPC) substrate, also known as a Stone Polymer (Plastic) Composite (SPC).

The substrate 2 may be unfoamed.

The substrate 2 may consist of a single layer. In other examples, the substrate 2 may be multi-layered.

The extruder 11 may extrude the substrate 2 in continuous form. The substrate 2 may be in continuous form after having left the die of the extruder 11.

The substrate 2 may be conveyed between a first roller arrangement 20. The first roller arrangement 20 may comprise at least two rollers 21, 22, 23, 24. The substrate 2 may be calendered to a desired thickness by passing through the first roller arrangement 20. The rollers 21, 22, 23, 24 of the first roller arrangement 20 may be calender rollers.

The substrate 2 is conveyed in a feeding direction F.

A foam layer 3 is applied on a first surface 2a of the substrate 2 after the substrate 2 has left the die, and in the example of FIG. 1, passed the first roller arrangement 20. The foam layer 3 is applied to the substrate 2 when the first surface 2a of the substrate 2 has a temperature exceeding ambient temperature, such as a temperature at the first surface 2a of the substrate 2 exceeds 20° C., or exceeds 30° C., or exceeds 40° C. The first surface 2a of the substrate may have a temperature of 120-240° C. when the foam layer 3 is to be applied, such as 140-220° C. In another example, the foam layer 3 may be applied on the first surface 2a of the substrate 2 when the first surface 2a of the substrate 2 has a temperature of 80-240° C., such as 80-160° C.

In one example, no cooling, such as no active cooling is provided prior to applying the foam layer 3.

The foam layer 3 is adhered to the substrate 2 at least partly by heat from the extruded substrate 2. For example, the foam layer 3 is laminated to the substrate 2.

The substrate 2 may remain at an elevated temperature, wherein the heat originates from the extrusion process, when the foam layer 3 is adhered to the substrate 2.

The foam layer 3 may be bonded to the substrate 2 at least partly by heat originating from the extrusion process.

By applying the foam layer 3 when the first surface 2a of the substrate 2 has an elevated temperature, the foam layer 3 can be adhered to the substrate without any adhesive. The use of adhesive can thereby be reduced, thus facilitating the manufacturing process and reducing potentially harmful chemicals. Further, the foam layer 3 is provided as an integrated part of the substrate 2.

As the foam layer 3 is bonded to the substrate 2, the foam layer 3 may be considered as an integrated part of the substrate 2. When a substrate element 10 or panel 100 is formed, the substrate element 10 or the panel 100 can be handled and/or installed without any separate foam layer, as the foam layer 3 is provided on the substrate 2.

The foam layer 3 may be bonded to the substrate 2 without any intervening layer.

The foam layer 3 is laminated to the first surface 2a of the substrate 2. In the example shown in FIG. 1, the foam layer 3 is applied to the substrate 2 between the first and second roller 31, 32 of a second roller arrangement 30. The foam layer 3 is adhered to the substrate 2 by applying pressure to the foam layer 3 and/or substrate 2, for example by the at least two rollers 31, 32.

Pressure may be applied by the first and second roller 31, 32 of the second roller arrangement 30. A distance between the first and second roller 31, 32 may be less than a total thickness of the substrate 2 and the foam layer 3. The distance between the first and second roller 31, 32 may exceed the thickness of the substrate 2, such as exceed or being equal to the total thickness of the substrate 2 and the foam layer 3 when being fully compressed.

The first and second roller 31, 32 of the second roller arrangement 30 may not be heated. The first and second roller 31, 32 may not be pre-heated. In one example, at least one of the first and second roller 31, 32 may be cooled, such as the roller 31 being in contact with the foam layer 3. In one example, heat is not actively added to the first and second roller 31, 32. In one example, the first and second roller 31, 32 are not actively cooled.

The foam layer 3 may be continuously applied to the substrate 2. The foam layer 3 may be applied to the substrate 2 in continuous form, such as in form of a continuous sheet. The foam layer 3 may be provided on roll form. The substrate 2 may be in continuous form when the foam layer 3 is adhered to the substrate 2.

The foam layer 3 may be adhered to the substrate 2 in a continuous process, which the substrate 2 is continuous from the die of the extruder 11 to the lamination process wherein the foam layer 3 is adhered to the substrate 2.

The foam layer 3 may be adhered to the substrate 2 adjacent the extruder 11. The foam layer 3 may be adhered to the substrate 2 no later than 10 minutes after the substrate 2 has left the die of the extruder 11, such as no later than 5 minutes, such as no later than 1 minute, such as no later than 30 seconds. A line speed may be 1-2 m/min.

In other examples, the line speed may be 1-10 m/min, such as 2-5 m/min.

Heat may also be applied to the substrate 2 and/or the foam layer 3, as an alternative or complement to heat originating from the extruded substrate 2. Heat may be applied by the at least two rollers 31, 32.

The foam layer 3 may be adhered to the substrate 2 prior to cooling the substrate 2. The foam layer 3 may be laminated to the substrate 2 in vicinity, for example in close vicinity, after the substrate 2 has passed the die of the extruder 11. For example, within 10 m of substrate length, or 5 m of substrate length, or 3 m of substrate length.

In the example shown in FIG. 1, the foam layer 3 is adhered directly to the first surface 2a of the substrate 2.

The foam layer 3 is adhered to the first surface 2a of the substrate 2 without any adhesive.

However, it is not excluded that a primer may be arranged between the first surface 2a of the substrate 2 and the foam layer 3. Such primer is configured to improve adhesion to the foam layer 3 but does not constitute an adhesive.

For example, a primer does not provide sufficient bonding strength to exceed the force of gravity when the foam layer is facing downwards. An adhesive is a substance configured to bond two surfaces together by resisting their separation.

The primer may be an adhesion promotor. The primer may be configured to improve adhesion of subsequent layers.

In one example, the foam layer 3 may be pre-heated prior to being applied to the first surface 2a of the substrate.

The foam layer 3 may be pre-heated on a surface of the foam layer 3 intended to face the first surface 2a of the substrate 2.

The foam layer 3 may be pre-heated by IR, hot air, or heat gun.

The foam layer, such as the surface of the foam layer 3 intended to face the first surface 2a of the substrate 2, may be pre-heated to a temperature exceeding ambient temperature, such as exceeding 20° C., such as exceeding 30° C., such as exceeding 40° C.

The foam layer 3 has a foamed structure. The foamed structure may comprise cells or pores in a closed and/or in an open cell structure. The foam layer 3 is compressible.

The thickness of the foam layer 3 may be 0.25-5 mm, such as 0.5-3 mm, 0.65-2.55 mm. The density of the foam layer 3 may be less than 700 kg/m³, such as less than 500 kg/m³. The density of the foam layer 3 is less than the density of the substrate 2.

The thickness may be measured in a direction perpendicular to a plane formed by a surface of the foam layer 3 adhered to the substrate 2.

The foam layer 3 is foamed, for example by a blowing agent. The foam layer 3 may have a compressive strength about 50-900 kPa (at 0.5 mm) as measured in accordance with EN16354:2018, such as 100-600 kPa (at 0.5 mm) as measured in accordance with EN16354:2018. Thereby, sound insulating properties may be obtained, and the foam layer 3 may be adapted to irregularities of a sub-structure, such as a sub-floor.

The foam layer 3 comprises a polymer material, such as a thermoplastic polymer material or a cross-linked thermoplastic polymer material. For example, the thermoplastic polymer may comprise or be polyvinyl chloride (PVC), polypropylene (PP), polyethylene (PE), polyethylene terephthalate (PET), or a combination thereof.

The thermoplastic polymer of the foam layer 3 and the thermoplastic polymer of the substrate 2 may be of the same type of polymer. By same type of polymer material is meant comprising the same monomer. In case of co-polymers, at least 50% of the thermoplastic co-polymer comprises the same monomer as the other thermoplastic polymer, or co-polymer. In examples, at least 75%, such as at least 75% of the thermoplastic co-polymer comprises the same monomer as the other thermoplastic polymer, or co-polymer.

In an example wherein the same type of thermoplastic polymer is PVC, the thermoplastic polymer of the foam layer 3 and the thermoplastic polymer of the substrate 2 may each be selected from the group of S-PVC, E-PVC, M-PVC and co-polymers with polyvinyl acetate, polyolefins and polyacrylates.

In an example wherein the same type of thermoplastic polymer is PP, the thermoplastic polymer of the foam layer 3 and the thermoplastic polymer of the substrate 2 may each be selected from the group of homopolymers, random co-polymers and block co-polymers of PP.

In an example wherein the same type of thermoplastic polymer is PE, the thermoplastic polymer of the foam layer 3 and the thermoplastic polymer of the substrate 2 may each be selected from the group of LDPE, HDPE, LLDPE, crosslinked PE, and UHMWPE.

In an example wherein the same type of thermoplastic polymer is PET, the thermoplastic polymer of the foam layer 3 and the thermoplastic polymer of the substrate 2 may each be selected from the group of PET, A-PET, R-PET and PET-G.

When the foam layer 3 and the substrate 2 comprise the same type of thermoplastic polymer, adherence between the foam layer 3 and the substrate 2 is improved. Further, when product in which the substrate 2 with the integrated foam layer 3 is worn out, there is no need to separate the foam layer 3 from the substrate 2 prior to recycling if the foam layer 3 and the substrate 2 comprises the same type of thermoplastic polymer. The product can thereby be recycled in an improved manner, and the resulting recyclate will be more useful since it does not comprise a mix of different polymers.

After the foam layer 3 has been applied and adhered to the first surface 2a of the substrate 2, the substrate 2 provided with the foam layer 3 may pass a cooling zone 80.

The substrate 2 provided with the foam layer 3 may be referred to as a board 1, comprising the substrate 2 and the foam layer 3.

The substrate 2 provided with the foam layer 3 may be cut by a cutting device 70 into a substrate element 10. The size of the substrate element 10 may exceed a size of a panel 100, such that the substrate element 10 may be divided into two or more panels 100 in a later step. The substrate element 10 may have a length corresponding to a length of the panel 100 to be formed but have a width corresponding to a width of two or more panels 100 to be formed. In another example, the substrate 2 provided with the foam layer 3 may be cut directly to a shape and size corresponding to a panel 100.

The substrate element 10 may be configured to form, or form part of a building element, such as a floor element.

In other examples, cutting is not required, and the substrate 2 provided with the foam layer 3 may consequently be referred to the substrate element 10 also without the cutting step.

The panel 100 may be a building panel, such as a floor panel, a wall panel, a furniture component, a building component, a worktop, etc.

In a prior, simultaneous, or subsequent step as the application of the foam layer 3, a surface layer 4, such as a décor layer, may be applied to a second surface 2b of the substrate 2, opposite the foam layer 3.

FIG. 2 illustrates that the surface layer 4 is adhered, for example by lamination, to a second surface 2b of the substrate 2. The surface layer 4 may be laminated to the substrate 2 by at least two rollers 41, 42 of a third roller arrangement 40. The surface layer 4 may be laminated to the substrate 2 by heat and/or pressure.

Pressure may be applied by the at least two rollers 41, 42 of the third roller arrangement 40. A distance between the rollers 41, 42 may be less than a total thickness of the substrate 2, the surface layer 4, and the foam layer 3.

In one example, at least one of the two rollers 41, 42 of the third roller arrangement 40 may be heated to laminate the surface layer 4 to the substrate 2, such as the roller 42 being in contact with the surface layer 4.

The surface layer 4 may comprise or be a decorative layer 4a. The decorative layer 4a may be a film provided with a print or pattern. The decorative layer 4a may be a polymeric film, such as a thermoplastic film. The decorative layer 4a may be a printed polymeric film, such as a printed thermoplastic film. The thermoplastic film may comprise a thermoplastic polymer such as PVC, PE, PP, TPU, PET, EVA, PA, PS, PVAc, PMMA, PVB, PC, ABS, PAM, PBT, or CPVC.

In the example of FIG. 2, the decorative layer 4a is laminated to the substrate 2 by the at least two rollers 41, 42 of the third roller arrangement 40.

Pressure may be applied by the at least two rollers 41, 42 of the third roller arrangement 40 to laminate the decorative layer 4a to the substrate 2. A distance between the rollers 41, 42 may be less than a total thickness of the substrate 2, the decorative layer 4a, and the foam layer 3.

In one example, at least one of the rollers 41, 42 of the third roller arrangement 40 may be heated to laminate the decorative layer 4a to the substrate 2, such as the roller 42 being in contact with the decorative layer 4a.

In other examples, the decorative layer 4a may be provided by digital printing a print on the second surface 2b of the substate 2, or by digital printing a print on a print layer, corresponding to the decorative layer 4a, arranged on the second surface 2b of the substrate 2.

The surface layer 4 may further comprise a wear layer 4b, as in the example illustrated in FIG. 2. The wear layer 4b may be applied on the decorative layer 4a. The wear layer 4b may be applied on a surface of the decorative layer 4a opposite the substrate 2. The wear layer 4b may be laminated to the decorative layer 4a by at least two further rollers 43, 44 of the third roller arrangement 40. The wear layer 4b may be laminated to the decorative layer 4a by heat and/or pressure.

Pressure may be applied by the at least two further rollers 43, 44 of the third roller arrangement 40 to laminate the wear layer 4b to the decorative layer 4a. A distance between the rollers 43, 44 may be less than a total thickness of the substrate 2, the decorative layer 4a, the wear layer 4b, and the foam layer 3.

In one example, at least one of the further rollers 43, 44 of the third roller arrangement 40 may be heated to laminate the wear layer 4b to the decorative layer 4a, such as the roller 44 being in contact with the wear layer 4b.

The wear layer 4b may be a polymeric film, such as a thermoplastic film. The thermoplastic film may comprise a thermoplastic polymer such as PVC, PE, PP, TPU, PET, EVA, PA, PS, PVAc, PMMA, PVB, PC, ABS, PAM, PBT, or CPVC.

A coating (not shown), such as a radiation curable coating, may be applied on the wear layer 4b, or on the decorative layer 4a, if the wear layer 4b is excluded.

A cooling zone (not shown) may be provided, prior and/or after lamination of the surface layer 4.

In an alternative example, the decorative layer 4a and the wear layer 4b may be laminated to each other prior to lamination on the substrate 2 as the surface layer 4. In another example, the surface layer 4 comprises a single layer, such as the decorative layer 4a.

The example shown in FIG. 3 corresponds to the example described above with reference to FIG. 1 in respect of the extrusion process, the substrate 2, the foam layer 3 and the lamination process of the foam layer 3 to the first surface 2a of the substrate 2. FIG. 3 shows further that a surface layer 4 is adhered, for example by lamination, to a second surface 2b of the substrate 2. The surface layer 4 may be laminated to the substrate 2 by at least two rollers 41, 42 of a third roller arrangement 40. The surface layer 4 may be laminated to the substrate 2 by heat and/or pressure.

Pressure may be applied by the at least two rollers 41, 42 of the third roller arrangement 40 to laminate the surface layer 4 to the substrate 2. A distance between the rollers 41, 42 may be less than a total thickness of the substrate 2 and the surface layer 4.

In one example, at least one of the rollers 41, 42 of the third roller arrangement 40 may be heated to laminate the surface layer 4 to the substrate 2, such as the roller 42 being in contact with the surface layer 4.

The foam layer 3 may be laminated to the first surface 2a of the substrate 2 by the second roller arrangement 30 as described above with reference to FIG. 1. The foam layer 3 may be adhered to the substrate 2 after the surface layer 4 has been applied, as shown in FIG. 3.

Pressure may be applied by the first and second roller 31, 32 of the second roller arrangement 30 to apply the foam layer 3 on the substrate 2. A distance between the first and second roller 31, 32 may be less than a total thickness of the substrate 2, the surface layer 4, and the foam layer 3. The distance between the first and second roller 31, 32 may exceed the total thickness of the substrate 2 and the surface layer 4, such as exceed or being equal to the total thickness of the substrate 2, the surface layer 4 and the foam layer 3 when being fully compressed.

The first and second roller 31, 32 of the second roller arrangement 30 may not be heated. The first and second roller 31, 32 may not be pre-heated. In one example, at least one of the first and second roller 31, 32 may be cooled, such as the roller 31 being in contact with the foam layer 3. In one example, heat is not actively added to the first and second roller 31, 32. In one example, the first and second roller 31, 32 are not actively cooled.

The surface layer 4 may comprise or be a decorative layer 4a. The decorative layer 4a may be a film provided with a print or pattern. The decorative layer 4a may be a polymeric film, such as a thermoplastic film. The decorative layer 4a may be a printed polymeric film, such as a printed thermoplastic film. The thermoplastic film may comprise a thermoplastic polymer such as PVC, PE, PP, TPU, PET, EVA, PA, PS, PVAc, PMMA, PVB, PC, ABS, PAM, PBT, or CPVC. A coating (not shown), such as a radiation curable coating, may be applied on the surface layer 4.

In other examples, the decorative layer 4a may be provided by digital printing a print on the second surface 2b of the substate 2, or by digital printing a print on a print layer, corresponding to the decorative layer 4a, arranged on the second surface 2b of the substrate 2.

The surface layer 4 may further comprise a wear layer 4b. The wear layer 4b may be applied on the decorative layer 4a. The wear layer 4b may be applied on a surface of the decorative layer 4a opposite the substrate 2. The wear layer 4b may be a polymeric film, such as a thermoplastic film. The thermoplastic film may comprise a thermoplastic polymer such as PVC, PE, PP, TPU, PET, EVA, PA, PS, PVAc, PMMA, PVB, PC, ABS, PAM, PBT, or CPVC.

The decorative layer 4a and the wear layer 4b may be laminated to each other prior to lamination on the substrate 2 as the surface layer 4. In another example, the surface layer 4 comprises a single layer, such as the decorative layer 4a.

In another example, the wear layer 4b may be applied on the decorative layer 4a in a further lamination step, as illustrated in FIG. 2.

A coating (not shown), such as a radiation curable coating, may be applied on the wear layer.

A cooling zone (not shown) may be provided, prior and/or after lamination of the surface layer 4.

The substrate 2 provided with the foam layer 3 and the surface layer 4 may be referred to as a board 1, comprising the substrate 2, the foam layer 3 and the surface layer 4.

As already described above with reference to FIG. 1, the substrate 2 provided with the integrated foam layer 3 may be cut in a cutting device 70 into a substrate element 10.

The size of the substrate element 10 may exceed a size of a panel 100, such that the substrate element 10 may be divided into two or more panels 100 in a later step. The substrate element 10 may have a length corresponding to a length of the panel 100 to be formed but have a width corresponding to a width of two or more panels 100 to be formed. In another example, the substrate 2 with the integrated foam layer 3 may be cut directly to a shape and size corresponding to a panel 100.

The substrate element 10 may be configured to form, or form part of a building element, such as a floor element.

In other examples, cutting is not required, and the substrate 2 provided with the foam layer 3 may consequently be referred to the substrate element 10 also without the cutting step.

The panel 100 may be a building panel, such as a floor panel, a wall panel, a furniture component, a building component, a worktop, etc.

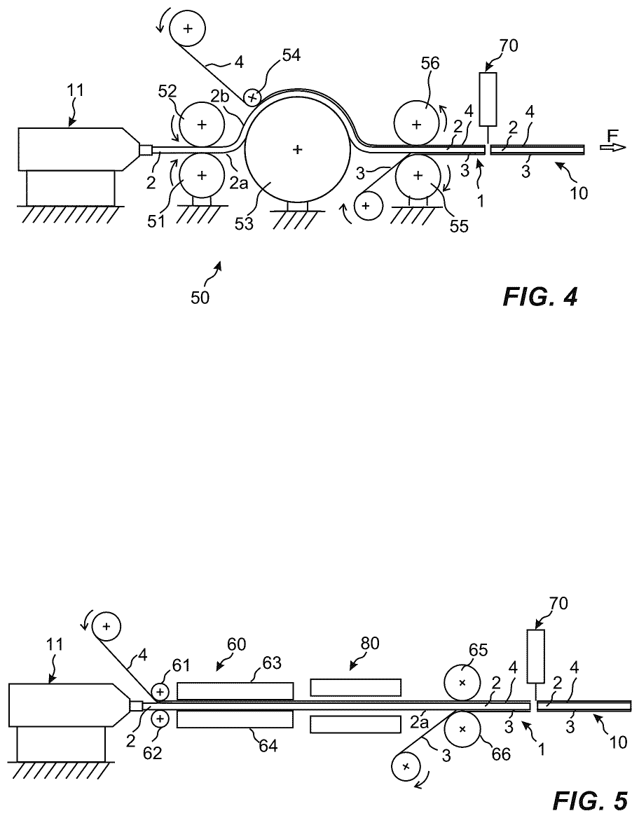

FIG. 4 shows another example of a method to produce a substrate 2 provided with a foam layer 3. The substrate 2 may be, or be configured to form part, of a building panel, such as a floor panel, a wall panel, a furniture component, a building component, a worktop, etc. The method may be an example of a Solid Polymer Core (SPC) process, also known as a Stone Polymer (Plastic) Composite (SPC). The substrate may be a Solid Polymer Core (SPC) substrate, also known as a Stone Polymer (Plastic) Composite (SPC) substrate.

The substrate 2 provided with the foam layer 3 may form a substrate element 10, for example, a building element, such as a floor element.

The method may be directed to form a panel 100 configured for flooring, a board 1 configured for flooring, or a substrate element 10 configured for flooring, depending on the size of produced product.

The method comprises extruding a substrate 2 through a die of an extruder 11, similar to as described above with reference to FIG. 1. The substrate 2 may be extruded as one layer, or may comprise one or more extruded substrate layers forming the substrate 2.

The extruder 11 may be a twin screw extruder. Other any other type of extruder may be used, such as a two-step extruder, kneader, continuous mixer, planetary roller extruder, etc. The extruder may comprise a die, through which the material leaves the extruder.

The substrate 2 comprises a polymer material, such as a thermoplastic polymer material. The thermoplastic polymer material may comprise thermoplastic polymers, such as polyvinyl chloride (PVC), polypropylene (PP), polyethylene (PE), polyethylene terephthalate (PET), or a combination thereof. The substrate 2 may comprise the thermoplastic polymer material in an amount of 10-40 wt %, such as 15-35 wt %. The substrate 2 may further comprise at least one inorganic or organic filler, preferably in an amount exceeding 40 wt %, more preferably exceeding 60 wt %, such as 50-90 wt % or 60-80 wt %. For example, the inorganic filler may be a mineral material, for example CaCO₃, talc, fly ash, or a stone material, such as stone powder. Examples of CaCO₃ may be marble, limestone or chalk. The organic filler may a wood material, a bamboo material, cork husk, or rice husks. For example, the wood material may be wood fibres, wood flour and/or wood dust, and the bamboo material may be bamboo dust.

In one example, the thermoplastic polymer of the substrate 2 is not polyethylene (PE).

A density of the substrate 2 may be 800-2200 kg/m³. The substrate 2 may have a thickness of 2-18 mm, such as 3-12 mm, preferably 4-8 mm.

The substrate 2 may be a rigid substrate, such as a Solid Polymer Core (SPC) substrate, also known as a Stone Polymer (Plastic) Composite (SPC) substrate.

The extruder 11 is extruding the substrate 2 in continuous form. The substrate 2 is in continuous form after having left the die of the extruder 11.

The substrate 2 is conveyed between a roller arrangement 50. The roller arrangement may comprise at least two pair of rollers 51, 52, 53, 54, 55, 56.

In the method shown in FIG. 4, the extruded substrate is conveyed between a first pair of rollers 51, 52. The first pair of rollers 51, 52 may calibrate the thickness of the substrate 2. The first pair of rollers 51, 52 may be calender rolls.

A surface layer 4 is applied to a second surface 2b of the substrate 2 by a second pair of rollers 53, 54. The rollers 53, 34 of the second pair of rollers may have different diameters.

Pressure may be applied by the second pair of rollers 53, 54 to laminate the surface layer 4 to the substrate 2. A distance between the rollers 53, 54 may be less than a total thickness of the substrate 2 and the surface layer 4.

In one example, at least one of the rollers 53, 54 may be heated to laminate the surface layer 4 to the substrate 2, such as the roller 54 being in contact with the surface layer 4.

The surface layer 4 may comprise or be a decorative layer 4a. The decorative layer 4a may be a film provided with a print or pattern. The decorative layer 4a may be a polymeric film, such as a thermoplastic film. The decorative layer 4a may be a printed polymeric film, such as a printed thermoplastic film. The thermoplastic film may comprise a thermoplastic polymer such as PVC, PE, PP, TPU, PET, EVA, PA, PS, PVAc, PMMA, PVB, PC, ABS, PAM, PBT, or CPVC.

In other examples, the decorative layer 4a may be provided by digital printing a print on the second surface 2b of the substate 2, or by digital printing a print on a print layer, corresponding to the decorative layer 4a, arranged on the second surface 2b of the substrate 2.

The surface layer 4 may further comprise a wear layer 4b. The wear layer 4b may be laminated to the decorative layer 4a such that a surface layer 4 including both the wear layer and the decorative layer is applied on the substrate 2 by the rollers 53, 54. In another examples, the wear layer 4b may be laminated to the decorative layer 4a when the decorative layer 4a is arranged on the substrate 2, as in the example illustrated in FIG. 4.

The wear layer 4b may be a polymeric film, such as a thermoplastic film. The thermoplastic film may comprise a thermoplastic polymer such as PVC, PE, PP, TPU, PET, EVA, PA, PS, PVAc, PMMA, PVB, PC, ABS, PAM, PBT, or CPVC.

For simplicity, only the surface layer 4 is illustrated in FIG. 4.

After the surface layer 4 has been applied, a foam layer 3 is adhered to a first surface 2a of the substrate 2. In the example shown in FIG. 4, the foam layer 3 is applied to the substrate 2 between the third pair of rollers 55, 56.

The foam layer 3 is laminated to the substrate 2 by applying pressure to the foam layer 3 and/or substrate 2, for example by the third pair of rollers 55, 56.

The foam layer 3 is applied on a first surface 2a of the substrate 2 after the substrate 2 has left the die and, in the example of FIG. 4, the first and second pair of rollers.

The foam layer 3 is applied to the substrate 2 when the first surface 2a of the substrate 2 has a temperature exceeding ambient temperature, such as a temperature at the first surface 2a of the substrate 2 exceeds 20° C., for example exceeding 30° C., such as exceeding 40° C. The first surface 2a of the substrate may have a temperature of 120-240° C. when the foam layer 3 is to be applied, such as 140-220° C. In another example, the foam layer 3 may be applied on the first surface 2a of the substrate 2 when the first surface 2a of the substrate 2 has a temperature of 80-240° C. after extrusion, such as 80-160° C.

In one example, no cooling, such as no active cooling is provided prior to applying the foam layer 3.

The foam layer 3 is adhered to the substrate 2 at least partly by heat from the extruded substrate 2. For example, the first surface 2a of the substrate 2 the foam layer 3 is laminated to the substrate 2.

The substrate 2 may remain at an elevated temperature, wherein the heat originals from the extrusion process, when the foam layer 3 is adhered to the substrate 2.

The foam layer 3 may be adhered to the substrate 2 at least partly by heat stored in the extruded substrate 2, wherein the heat is originating from the extrusion process.

The foam layer 3 may be bonded to the substrate 2 at least partly by heat originating from the extrusion process.

By applying the foam layer 3 when the first surface 2a of the substrate 2 has an elevated temperature, the foam layer 3 can be adhered to the substrate without any adhesive. The use of adhesive can thereby be reduced, thus facilitating the manufacturing process and reducing potentially harmful chemicals. Further the foam layer 3 is provided as an integrated part of the substrate 2.

As the foam layer 3 is bonded to the substrate 2, the foam layer 3 may be considered as an integrated part of the substrate 2. When a panel is formed, the panel can be handled and/or installed without any separate foam layer, as the foam layer 3 is provided on the substrate 2.

The foam layer 3 may be bonded to the substrate without any intervening layer.

The foam layer 3 is laminated to a first surface 2a of the substrate 2. In the example shown in FIG. 4, the foam layer 3 is applied to the substrate 2 between a third pair of rollers 55, 56. The foam layer 3 is adhered to the substrate 2 by applying pressure to the foam layer 3 and/or substrate 2, for example by the third pair of rollers 55, 56.

Pressure may be applied by the third pair of rollers 55, 56 to apply the foam layer 3 on the substrate 2. A distance between the third pair of rollers 55, 56 may be less than a total thickness of the substrate 2, the surface layer 4, and the foam layer 3. The distance between the third pair of rollers 55, 56 may exceed the total thickness of the substrate 2 and the surface layer 4, such as exceed or being equal to the total thickness of the substrate 2, the surface layer 4 and the foam layer 3 when being fully compressed.

The third pair of rollers 55, 56 may not be heated. The third pair of rollers 55, 56 may not be pre-heated. In one example, at least one of the rollers 55, 56 may be cooled, such as the roller 55 being in contact with the foam layer 3. In one example, heat is not actively added to the third pair of rollers 55, 56. In one example, the third pair of rollers 55, 56 are not actively cooled.

In an alternative example, the foam layer 3 may be applied to the substrate after the third pair of rollers 55, 56, for example by a fourth pair of rollers (not shown).

The foam layer 3 may be continuously applied to the substrate 2. The foam layer 3 may be applied to the substrate 2 in continuous form, such as in form of a continuous sheet. The foam layer 3 may be provided on roll form. The substrate 2 may be in continuous form when the foam layer 3 is adhered to the substrate 2.

The foam layer 3 may be adhered to the substrate 2 in a continuous process, in which the substrate 2 is continuous from the die of the extruder 11 to the lamination process wherein the foam layer 3 is adhered to the substrate 2.

The foam layer 3 may be adhered to the substrate 2 adjacent the extruder 11. The foam layer 3 may be adhered to the substrate 2 no later than 10 minutes after the substrate 2 has left the die of the extruder 11, such as no later than 5 minutes, such as no later than 1 minute, such as no later than 30 seconds. A line speed may be 1-2 m/min. In other examples, the line speed may be 1-10 m/min, such as 2-5 m/min.

The foam layer 3 may be adhered to the substrate 2 prior to cooling the substrate 2. The foam layer 3 may be laminated to the substrate 2 in vicinity, for example in close vicinity, after the substrate 2 has passed the die of the extruder 11.

For example, within 10 m of substrate length, or 5 m of substrate length, or 3 m of substrate length.

In the example shown in FIG. 4, the foam layer 3 is adhered directly to the first surface 2a of the substrate 2.

The foam layer 3 is adhered to the first surface 2a of the substrate 2 without any adhesive.

However, it is not excluded that a primer may be arranged between the first surface 2a of the substrate 2 and the foam layer 3. Such primer is configured to improve adhesion to the foam layer 3 but does not constitute an adhesive.

For example, a primer does not provide sufficient bonding strength to exceed the force of gravity when the foam layer is facing downwards. An adhesive is a substance configured to bond two surfaces together by resisting their separation.

The primer may be an adhesion promotor. The primer may be configured to improve adhesion of subsequent layers.

In one example, the foam layer 3 may be pre-heated prior to being applied to the first surface 2a of the substrate.

The foam layer 3 may be pre-heated on a surface of the foam layer 3 intended to face the first surface 2a of the substrate 2.

The foam layer 3 may be pre-heated by IR, hot air, or heat gun.

The foam layer 3, such as a surface of the foam layer 3 intended to face the first surface 2a of the substrate 2, may be pre-heated to a temperature exceeding ambient temperature, such as exceeding 20° C., such as exceeding 30° C., such as exceeding 40° C.

The foam layer 3 has a foamed structure. The foamed structure may comprise cells or pores in a closed and/or in an open cell structure. The foam layer 3 is compressible.

The thickness of the foam layer 3 may be 0.25-5 mm, such as 0.65-2.55 mm. The density of the foam layer 3 may be less than 700 kg/m³, such as less than 500 kg/m³. The density of the foam layer 3 is less than the density of the substrate 2.

The foam layer 3 2 is foamed, for example by a blowing agent. The foam layer 3 may have a compressive strength about 50-900 kPa (at 0.5 mm) as measured in accordance with EN16354:2018, such as 100-600 kPa (at 0.5 mm) as measured in accordance with EN16354:2018. Thereby, sound insulating properties may be obtained, and the foam layer 3 may be adapted to irregularities of a sub-structure, such as a sub-floor.

The foam layer 3 comprises a polymer material, such as a thermoplastic polymer material or a cross-linked thermoplastic polymer material. For example, the thermoplastic polymer may comprise or be polyvinyl chloride (PVC), polypropylene (PP), polyethylene (PE), polyethylene terephthalate (PET), or a combination thereof.

The thermoplastic polymer of the foam layer 3 and the thermoplastic polymer of the substrate 3 may be of the same type of thermoplastic polymer. By same type of thermoplastic polymer is considered thermoplastic polymers comprising the same monomer. In case of co-polymers, at least 50% of the thermoplastic co-polymer comprises the same monomer as the other thermoplastic polymer, or co-polymer. In other examples, the co-polymer may comprise at least 75% such as at least 90% of the same monomer as the other thermoplastic polymer, or co-polymer.

In an example wherein the same type of thermoplastic polymer is PVC, the thermoplastic polymer of the foam layer 3 and the thermoplastic polymer of the substrate 2 may each be selected from the group of S-PVC, E-PVC, M-PVC and co-polymers with polyvinyl acetate, polyolefins or polyacrylates.

In an example wherein the same type of thermoplastic polymer is PP, the thermoplastic polymer of the foam layer 3 and the thermoplastic polymer of the substrate 2 may each be selected from the group of homopolymers, random co-polymers and block co-polymers of PP.

In an example wherein the same type of thermoplastic polymer is PE, the thermoplastic polymer of the foam layer 3 and the thermoplastic polymer of the substrate 2 may each be selected from the group of LDPE, HDPE, LLDPE, crosslinked PE, and UHMWPE.

In an example wherein the same type of thermoplastic polymer is PET, the thermoplastic polymer of the foam layer 3 and the thermoplastic polymer of the substrate 2 may each be selected from the group of PET, A-PET, R-PET and PET-G.

When the foam layer 3 and the substrate 2 comprise the same type of polymer material, adherence between the foam layer 3 and the substrate 2 is improved. Further, when product in which the substrate 2 with the integrated foam layer 3 is worn out, there is no need to separate the foam layer 3 from the substrate 2 prior to recycling if the foam layer 3 and the substrate 2 comprises the same type of polymer. The product can thereby be recycled in an improved manner, and the resulting recyclate will be more useful since it does not comprise a mix of different polymers.

The substrate 2 provided with the foam layer 3 and the surface layer 4 may be referred to as a board 1, comprising the substrate 2, the surface layer 4 and the foam layer 3.

As shown in FIG. 4, the substrate 2 provided with the foam layer 3 may be cut by a cutting device 70 into a substrate element 10. The size of the substrate element 10 may exceed a size of a panel 100, such that the substrate element 10 may be divided into two or more panels 100 in a later step. The substrate element 10 may have a length corresponding to a length of the panel 100 to be formed but have a width corresponding to a width of two or more panels 100 to be formed. In another example, the substrate 2 with the integrated foam layer 3 may be cut directly to a shape and size corresponding to a panel 100.

The substrate element 10 may be configured to form, or form part of a building element, such as a floor element.

In other examples, cutting is not required, and the substrate 2 provided with the foam layer 3 may consequently be referred to the substrate element 10 also without the cutting step.

The panel 100 may be a building panel, such as a floor panel, a wall panel, a furniture component, a building component, a worktop, etc.

A cooling zone (not shown) may be included in the process, for example after the third pair of rollers 55, 56.

FIG. 5 shows another example of a method to produce a substrate 2. The substrate 2 may be, or be configured to form part, of a building panel, such as a floor panel, a wall panel, a furniture component, a building component, a worktop, etc. The method may be an example of an Expanded Polymer Core (WPC or EPC) process. The substrate 2 may be an Expanded Polymer Core (WPC or EPC) substrate.

The substrate 2 provided with the foam layer 3 may form, or form part of, substrate element 10, for example, a building element, such as a floor element.

The method may be directed to form a panel 100 configured for flooring, a board 1 configured for flooring, or a substrate element 10 configured for flooring, depending on the size of produced product.

The method comprises extruding a substrate 2 through a die of an extruder 11. The substrate 2 may be extruded as one layer, or may comprise one or more extruded substrate layers forming the substrate 2. In one example, the substrate 2 may be foamed.

The extruder 11 may be a twin screw extruder. Other any other type of extruder may be used, such as a two-step extruder, kneader, continuous mixer, planetary roller extruder, etc. The extruder may comprise a die, through which the material leaves the extruder.

The substrate 2 comprises a polymer material, such as thermoplastic polymer material. The thermoplastic polymer material may comprise thermoplastic polymers, such as polyvinyl chloride (PVC), polypropylene (PP), polyethylene (PE), polyethylene terephthalate (PET), or a combination thereof. The substrate 2 may comprise the thermoplastic polymer material in an amount of 10-40 wt %, such as 15-35 wt %. The substrate 2 may further comprise at least one inorganic or organic filler, preferably in an amount exceeding 40 wt %, more preferably exceeding 60 wt %, such as 50-90 wt % or 60-80 wt %. For example, the inorganic filler may be a mineral material, for example CaCO₃, talc, fly ash, or a stone material, such as stone powder. Examples of CaCO₃ may be marble, limestone or chalk. The organic filler may a wood material, a bamboo material, cork husks, or rice husks. For example, the wood material may be wood fibres, wood flour and/or wood dust, and the bamboo material may be bamboo dust.

In one example, the thermoplastic polymer of the substrate 2 is not polyethylene (PE).

A density of the substrate 2 may be 800-2200 kg/m³. The substrate 2 may have a thickness of 2-18 mm, such as 3-12 mm, preferably 4-8 mm.

The extruder 11 is extruding the substrate 2 in continuous form. The substrate 2 is in continuous form after having left the die of the extruder 11.

A surface layer 4 is adhered to the second surface 2b of the substrate between a first pair of rollers 61, 62 of the pressing arrangement 60. The surface layer 4 may comprise or be a decorative layer 4a. The decorative layer 4a may be a film provided with a print or pattern. The decorative layer 4a may be a polymeric film, such as a thermoplastic film. The decorative layer 4a may be a printed polymeric film, such as a printed thermoplastic film. The thermoplastic film may comprise a thermoplastic polymer such as PVC, PE, PP, TPU, PET, EVA, PA, PS, PVAc, PMMA, PVB, PC, ABS, PAM, PBT, or CPVC.

In one example, the surface layer 4 comprises a sub-layer and a decorative layer 4a. The sub-layer may be a foamed thermoplastic layer.

In other examples, the decorative layer 4a may be provided by digital printing a print on the second surface 2b of the substate 2, or by digital printing a print on a print layer, corresponding to the decorative layer 4a, arranged on the second surface 2b of the substrate 2.

The surface layer 4 may further comprise a wear layer 4b. The wear layer 4b may be laminated to the decorative layer 4a such that a surface layer 4 including both the wear layer and the decorative layer 4a is applied on the substrate 2 by the press plates 63, 64 of the pressing arrangement 60. In another examples, the wear layer 4b may be laminated to the decorative layer when the decorative layer 4a is arranged on the substrate 2, as in the example illustrated in FIG. 2.

The wear layer 4b may be a polymeric film, such as a thermoplastic film. The thermoplastic film may comprise a thermoplastic polymer such as PVC, PE, PP, TPU, PET, EVA, PA, PS, PVAc, PMMA, PVB, PC, ABS, PAM, PBT, or CPVC.

For simplicity, only the surface layer 4 is illustrated in FIG. 5.

The surface layer 4 is laminated to the substrate 2 by applying pressure to the surface layer 4 and/or substrate 2, for example in a pressing arrangement 60 comprising a pair of press plates 63, 64. As an alternative to press plates, press belts may be provided.

Pressure may be applied by the press plates 63, 64 to laminate the surface layer 4 to the substrate 2. In one example, pressure applied by the press plates 63, 64 may be 0.2-0.5 MPa. Heat may be applied by at least one of the press plates 63, 64. In one example, a temperature of at least one of the press plates 63, 64 may be 135-210° C.

In an example wherein the substrate 2 is foamed, at least one cooling zone 80 may be required to stop the foaming reaction prior to applying the foam layer 3, as shown in FIG. 5.

The foam layer 3 is applied on a first surface 2a of the substrate 2 after the substrate 2 has left the die and, in the example of FIG. 5, the pressing arrangement 60. The foam layer 3 is applied to the substrate 2 when the first surface 2a of the substrate 2 has a temperature exceeding ambient temperature, such as a temperature at the first surface 2a of the substrate 2 exceeds 20° C., such as exceeding 30° C., such as exceeding 40° C. The first surface 2a of the substrate may have a temperature of 120-240° C. after extrusion, such as 140-220° C., for example 140-220° C. In another example, the foam layer 3 may be applied on the first surface 2a of the substrate 2 when the first surface 2a of the substrate 2 has a temperature of 80-240° C. after extrusion, such as 80-160° C.

The foam layer 3 may be adhered to the substrate 2 prior to cooling the substrate 2. The foam layer 3 may be laminated to the substrate 2 in vicinity, for example in close vicinity, after the substrate 2 has passed the die of the extruder 11. For example, within 10 m of substrate length, or 5 m of substrate length, or 3 m of substrate length.

The foam layer 3 is adhered to the substrate 2 at least partly by heat from the extruded substrate 2. For example, the first surface 2a of the substrate 2 the foam layer 3 is laminated to the substrate 2.

The foam layer 3 may be bonded to the substrate 2 at least partly by heat originating from the extrusion process.

The substrate 2 may remain at an elevated temperature, wherein the heat originals from the extrusion process, when the foam layer 3 is adhered to the substrate 2.

By applying the foam layer 3 when the first surface 2a of the substrate 2 has an elevated temperature, the foam layer 3 can be adhered to the substrate without any adhesive. The use of adhesive can thereby be reduced, thus facilitating the manufacturing process and reducing potentially harmful chemicals. Further the foam layer 3 is provided as an integrated part of the substrate 2.

As the foam layer 3 is bonded to the substrate 2, the foam layer 3 may be considered as an integrated part of the substrate 2. When a panel is formed, the panel can be handled and/or installed without any separate foam layer, as the foam layer 3 is provided on the substrate 2.

The foam layer 3 may be bonded to the substrate without any intervening layer.

The foam layer 3 is laminated to a first surface 2a of the substrate 2. In the example shown in FIG. 5, the foam layer 3 is applied to the substrate 2 between at least two rollers 65, 66. The foam layer 3 is adhered to the substrate 2 by applying pressure to the foam layer 3 and/or substrate 2, for example by the at least two rollers 65, 66.

Pressure may be applied by at least two rollers 65, 66 to apply the foam layer 3 to the substrate 2. A distance between the rollers 65, 66 may be less than a total thickness of the substrate 2, the surface layer 4 and the foam layer 3. The distance between the rollers 65, 66 may exceed the total thickness of the substrate 2 and the surface layer 4, such as exceed or being equal to the total thickness of the substrate 2, the surface layer 4, and the foam layer 3 when being fully compressed.

The at least two rollers 65, 66 may not be heated. The at least two rollers 65, 66 may not be pre-heated. In one example, at least one of the rollers 65, 66 may be cooled, such as the roller 66 being in contact with the foam layer 3. In one example, heat is not actively added to the at least two rollers 65, 66. In one example, the at least two rollers 65, 66 are not actively cooled.

The foam layer 3 may be continuously applied to the substrate 2. The foam layer 3 may be applied to the substrate 2 in continuous form, such as in form of a continuous sheet. The foam layer 3 may be provided on roll form. The substrate 2 may be in continuous form when the foam layer 3 is adhered to the substrate 2.

The foam layer 3 may be adhered to the substrate 2 in a continuous process, which the substrate 2 is continuous from the die of the extruder 11 to the lamination process wherein the foam layer 3 is adhered to the substrate 2.

The foam layer 3 may be adhered to the substrate 2 adjacent the extruder 11. The foam layer 3 may be adhered to the substrate 2 no later than 10 minutes after the substrate 2 has left the die of the extruder 11, such as no later than 5 minutes, such as no later than 1 minute, such as no later than 30 seconds. A line speed may be 1-2 m/min.

In other examples, the line speed may be 1-10 m/min, such as 2-5 m/min.

In the example shown in FIG. 5, the foam layer 3 is adhered directly to the first surface 2a of the substrate 2.

The foam layer 3 is adhered to the first surface 2a of the substrate 2 without any adhesive.

However, it is not excluded that a primer may be arranged between the first surface 2a of the substrate 2 and the foam layer 3. Such primer is configured to improve adhesion to the foam layer 3 but does not constitute an adhesive.

For example, a primer does not provide sufficient bonding strength to exceed the force of gravity when the foam layer is facing downwards. An adhesive is a substance configured to bond two surfaces together by resisting their separation.

The primer may be an adhesion promotor. The primer may be configured to improve adhesion of subsequent layers.

In one example, the foam layer 3 may be pre-heated prior to being applied to the first surface 2a of the substrate.

A surface of the foam layer 3 intended the face the first surface 2a of the substrate 2 may be pre-heated.

The foam layer 3 may be pre-heated by IR, hot air, or a heated surface, such as a heated roller.

The foam layer 3, such as the surface of the foam layer 3 intended to face the first surface 2a of the substrate 2, may be pre-heated to a temperature exceeding ambient temperature, such as exceeding 20° C., such as exceeding 30° C., such as exceeding 40° C.

The foam layer 3 has a foamed structure. The foamed structure may comprise cells or pores in a closed and/or in an open cell structure. The foam layer 3 is compressible.

The thickness of the foam layer 3 may be 0.25-5 mm, such as 0.65-2.55 mm. The density of the foam layer 3 may be less than 700 kg/m³, such as less than 500 kg/m³. The density of the foam layer 3 is less than the density of the substrate 2.

The foam layer 3 is foamed, for example by a blowing agent. The foam layer 3 may have a compressive strength about 50-900 kPa (at 0.5 mm) as measured in accordance with EN16354:2018, such as 100-600 kPa (at 0.5 mm) as measured in accordance with EN16354:2018. Thereby, sound insulating properties may be obtained, and the foam layer 3 may be adapted to irregularities of a sub-structure, such as a sub-floor.

The foam layer 3 comprises a polymer material, such as a thermoplastic polymer material or a cross-linked thermoplastic polymer material. For example, the thermoplastic polymer material may comprise or be polyvinyl chloride (PVC), polypropylene (PP), polyethylene (PE), polyethylene terephthalate (PET), or a combination thereof.

The thermoplastic polymer of the foam layer and the thermoplastic polymer of the substrate may be of the same type of thermoplastic polymer. By same type of thermoplastic polymer is considered thermoplastic polymers comprising the same monomer. In case of co-polymers, at least 50% of the thermoplastic co-polymer comprises the same monomer as the other thermoplastic polymer, or co-polymer. In other examples, the co-polymer may comprise at least 75% such as at least 90% of the same monomer as the other thermoplastic polymer, or co-polymer.

In an example wherein the same type of thermoplastic polymer is PVC, the thermoplastic polymer of the foam layer 3 and the thermoplastic polymer of the substrate 2 may each be selected from the group of S-PVC, E-PVC, M-PVC and co-polymers with polyvinyl acetate, polyolefins and polyacrylates.

In an example wherein the same type of thermoplastic polymer is PP, the thermoplastic polymer of the foam layer 3 and the thermoplastic polymer of the substrate 2 may each be selected from the group of homopolymers, random co-polymers and block co-polymers of PP.

In an example wherein the same type of thermoplastic polymer is PE, the thermoplastic polymer of the foam layer 3 and the thermoplastic polymer of the substrate 2 may each be selected from the group of LDPE, HDPE, LLDPE, crosslinked PE, and UHMWPE.

In an example wherein the same type of thermoplastic polymer is PET, the thermoplastic polymer of the foam layer 3 and the thermoplastic polymer of the substrate 2 may each be selected from the group of PET, A-PET, R-PET and PET-G.

When the foam layer 3 and the substrate 2 comprise the same type of polymer material is adherence between the foam layer 3 and the substrate 2 improved. Further, when product in which the substrate 2 with the integrated foam layer 3 is worn out, there is no need to separate the foam layer 3 from the substrate 2 prior to recycling if the foam layer 3 and the substrate 2 comprises the same type of polymer. The product can thereby be recycled in an improved manner, and the resulting recyclate will be more useful since it does not comprise a mix of different polymers.

The substrate 2 provided with the foam layer 3 and the surface layer 4 may be referred to as a board 1, comprising the substrate 2, the surface layer 4 and the foam layer 3.

As shown in FIG. 5, the substrate 2 provided with the integrated foam layer 3 and the surface layer 4 may be cut by a cutting device 70 into a substrate element 10. The size of the substrate element 10 may exceed a size of a panel 100, such that the substrate element 10 may be divided into two or more panels 100 in a later step. The substrate element 10 may have a length corresponding to a length of the panel 100 to be formed but have a width corresponding to a width of two or more panels 100 to be formed. In another example, the substrate 2 with the integrated foam layer 3 may be cut directly to a shape and size corresponding to a panel 100.

The substrate element 10 may be configured to form, or form part of a building element, such as a floor element.

In other examples, cutting is not required, and the substrate 2 provided with the foam layer 3 may consequently be referred to the substrate element 10 also without the cutting step.

The panel 100 may be a floor panel, a wall panel, a furniture component, a building component, or a worktop.

The panel 100 produced according to any one of the examples illustrated with reference to FIGS. 1-5 may be provided with a mechanical locking system along at least one edge thereof in a further step.

A moisture barrier may be included in the foam layer 3 in any of the examples described above with reference to FIGS. 1-5.

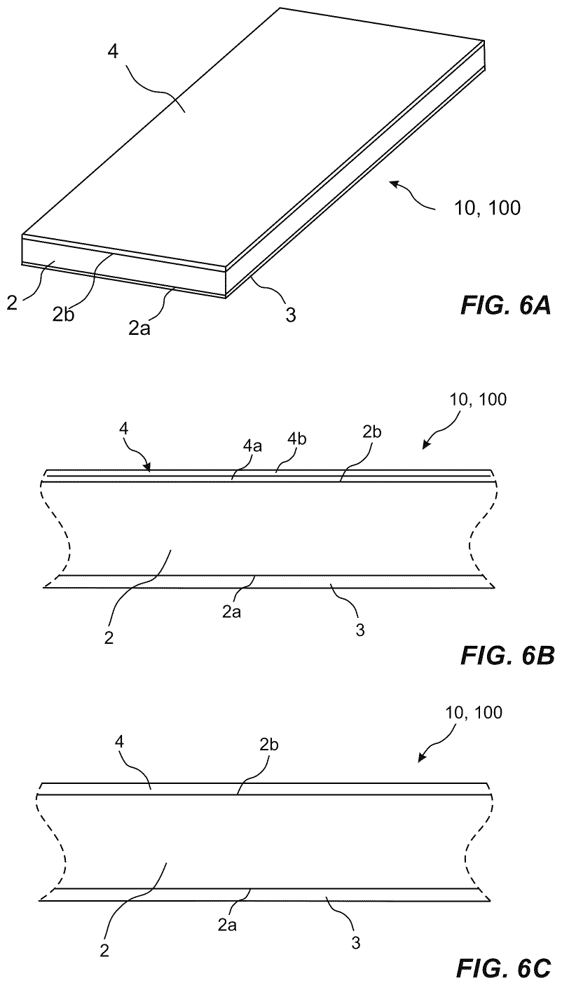

FIGS. 6A, 6B and 6C show a substrate element 10 or a building panel 100. The substrate element 10 or the building panel 100 may be produced according to any on one the method described above with reference to FIGS. 1-5. In the following, reference will only be made to a building panel 100, as it may only be the size that differs between the substrate element 10 and the building panel 100.

The building panel 100 may have a rectangular shape, as shown in FIG. 6A. The building panel 100 may be intended to be a floor panel, a wall panel, a furniture component, a building component, a worktop, etc. The building panel 100 may be provided with a mechanical locking system (not shown).

The mechanical locking system may be configured to join adjacent edges of the panels, such as floor panels.

The mechanical locking system may be at least partially formed in the substrate 2.

The building panels 100, such as floor panels, may be configured to each other in a floating installation.

The building panel 100 comprises the substrate 2 provided with the integrated foam layer 3 produced according to any one of the methods described above with reference to FIGS. 1-5. The integrated foam layer 3 is configured to face the sub-structure (not shown) when the building panel 100 is in use. For example, in case of a floor panel, the integrated foam layer 3 is configured a sub-floor onto which the floor panel is installed.

The foam layer 3 is bonded to the first surface 2a of the substrate 2 without any adhesive.

The foam layer 3 is configured to compensate for any unevenness of the sub sub-structure, such as the sub-floor. In case of floor panels, the foam layer 3 may reduce the risk of damaging components of the floor panels. Moreover, the underlay may improve the characteristics of the floor covering formed by the floor panels, such as its comfort and/or sound properties, e.g., the reflective walking sound and/or impact sound. In some configurations, the underlay may function as a moisture barrier. A moisture barrier layer (not shown) may be included in the foam layer 3.

The foam layer 3 has a foamed structure. The foamed structure may comprise cells or pores in a closed and/or in an open cell structure. The foam layer 3 may be compressible.

The thickness of the foam layer 3 may be 0.25-5 mm, such as 0.65-2.55 mm. The density of the foam layer 3 may be less than 700 kg/m³, such as less than 500 kg/m³. The density of the foam layer 3 is less than the density of the substrate 2.

The foam layer 3 may have a compressive strength about 50-900 kPa (at 0.5 mm) as measured in accordance with EN16354:2018, such as 100-600 kPa (at 0.5 mm) as measured in accordance with EN16354:2018.

The foam layer 3 comprises a polymer material, such as a thermoplastic polymer material or a cross-linked thermoplastic polymer material. For example, the thermoplastic polymer may comprise or polyvinyl chloride (PVC), polypropylene (PP), polyethylene (PE), polyethylene terephthalate (PET), or a combination thereof.

The substrate 2 comprises a polymer material, such as thermoplastic polymer material. The thermoplastic polymer material may comprise thermoplastic polymers, such as polyvinyl chloride (PVC), polypropylene (PP), polyethylene (PE), polyethylene terephthalate (PET), or a combination thereof. The substrate 2 may comprise the thermoplastic polymer material in an amount of 10-40 wt %, such as 15-35 wt %. The substrate 2 may further comprise at least one inorganic or organic filler, preferably in an amount exceeding 40 wt %, more preferably exceeding 60 wt %, such as 50-90 wt % or 60-80 wt %. For example, the inorganic filler may be a mineral material, for example CaCO₃, talc, fly ash, or a stone material, such as stone powder. Examples of CaCO₃ may be marble, limestone or chalk. The organic filler may a wood material, a bamboo material, cork husks, or rice husks. For example, the wood material may be wood fibres, wood flour and/or wood dust, and the bamboo material may be bamboo dust.

A density of the substrate 2 may be 800-2200 kg/m³. The substrate 2 may have a thickness of 2-18 mm, such as 3-12 mm, preferably 4-8 mm.

In one example, as for example in an Expanded Polymer Core (WPC or EPC) produce, the substrate 2 may be foamed.

The thermoplastic polymer of the foam layer 3 and the thermoplastic polymer of the substrate 2 may be of the same type of thermoplastic polymer. By same type of thermoplastic polymer is considered thermoplastic polymers comprising the same monomer. In case of co-polymers, at least 50% of the thermoplastic co-polymer comprises the same monomer as the other thermoplastic polymer, or co-polymer. In other examples, the co-polymer may comprise at least 75% such as at least 90% of the same monomer as the other thermoplastic polymer, or co-polymer.

In an example wherein the same type of thermoplastic polymer is PVC, the thermoplastic polymer of the foam layer 3 and the thermoplastic polymer of the substrate 2 may each be selected from the group of S-PVC, E-PVC, M-PVC and co-polymers with polyvinyl acetate, polyolefins and polyacrylates.

In an example wherein the same type of thermoplastic polymer is PP, the thermoplastic polymer of the foam layer 3 and the thermoplastic polymer of the substrate 2 may each be selected from the group of homopolymers, random co-polymers and block co-polymers of PP.

In an example wherein the same type of thermoplastic polymer is PE, the thermoplastic polymer of the foam layer 3 and the thermoplastic polymer of the substrate 2 may each be selected from the group of LDPE, HDPE, LLDPE, crosslinked PE, and UHMWPE.

In an example wherein the same type of thermoplastic polymer is PET, the thermoplastic polymer of the foam layer 3 and the thermoplastic polymer of the substrate 2 may each be selected from the group of PET, A-PET, R-PET and PET-G.

When the foam layer 3 and the substrate 2 comprise the same type of polymer material, adherence between the foam layer 3 and the substrate 2 is improved. Further, when product in which the substrate 2 with the integrated foam layer 3 is worn out, there is no need to separate the foam layer 3 from the substrate 2 prior to recycling if the foam layer 3 and the substrate 2 comprises the same type of polymer. The product can thereby be recycled in an improved manner, and the resulting recyclate will be more useful since it does not comprise a mix of different polymers.

The building panel may further comprise a surface layer 4 adhered to the second surface 2b of the substrate 2, opposite the foam layer 3. The surface layer 4 may comprise or be a decorative layer 4a. The decorative layer 4a may be a film provided with a print or pattern. The decorative layer 4a may be a polymeric film, such as a thermoplastic film. The decorative layer 4a may be a printed polymeric film, such as a printed thermoplastic film. The thermoplastic film may comprise a thermoplastic polymer such as PVC, PE, PP, TPU, PET, EVA, PA, PS, PVAc, PMMA, PVB, PC, ABS, PAM, PBT, or CPVC. A coating (not shown), such as a radiation curable coating, may be arranged on the surface layer 4.

As an alternative, a print may be printed on the second surface 2b of the substrate 2.

In other examples, the decorative layer 4a may be provided as a digital print printed on the second surface 2b of the substate 2, or as a digital print on a print layer, corresponding to the decorative layer 4a, arranged on the second surface 2b of the substrate 2.

The surface layer 4 may further comprise a wear layer 4b. The wear layer 4b may be laminated to the decorative layer 4a such that the surface layer 4 includes both the wear layer 4b and the decorative layer 4a.

The wear layer 4b may be a polymeric film, such as a thermoplastic film. The thermoplastic film may comprise a thermoplastic polymer such as PVC, PE, PP, TPU, PET, EVA, PA, PS, PVAc, PMMA, PVB, PC, ABS, PAM, PBT, or CPVC.

A coating (not shown), such as a radiation curable coating, may be arranged on the wear layer.

In the example illustrated in FIG. 6B, the surface layer 4 comprises the decorative layer 4a and the wear layer 4b.

In the example illustrated in FIG. 6C, the surface layer 4 comprises a single layer, such as the decorative layer 4a. For some applications, such as in an Expanded Polymer Core (WPC or EPC) product, a sub-layer (not shown) may be positioned between the surface layer 4 and the second surface 2b of the substrate 2.

It is contemplated that there are numerous modifications of the embodiments described herein, which are still within the scope of the disclosure as defined by the appended claims.

### EXAMPLES

### Foam Adhesion: PVC Substrate

A SPC mix was extruded to a strip. The SPC mix was 462-2 from Välinge Innovation Sweden AB. The SPC mix comprises 100 phr PVC (Norvinyl S5745), 200 phr filler (Greenafiller 0-100) and additives.

A foam layer was pressed to the extruded strip after extrusion. The foam layer was applied on a surface of the extruded strip directly after the strip had left the die of the extruder. The surface of the extruded strip had a temperature of 170° C. when the foam layer was applied on the surface.

Adhesion strength between the substrate formed by the extruded strip and the foam layer was assessed by separating the substrate and the foam layer by hand. Adhesion strength was graded by the following relative scale: 0: No bond at all; 1: Very poor bond; 2: Poor bond; 3 Good bond; 4: Strong bond; 5: Very strong bond.

Test results according to table 1 below.

TABLE 1

| | Thermo- | | | |
|---|---|---|---|---|
| | plastic | Thickness | | Adhesion |
| Foam layer | polymer | (mm) | Producer | strength |
| Topstar IXPP 1015 | PP | 1.5 | Topstar | 4 |
| Topstar IXPP 1010 | PP | 1 | Topstar | 4 |
| Soft silence | EVA | 1.5 | Shaw | 0 |
| Selit Bloc Griptech | XPS | 1.5 | Sekut | 0 |
| IXPV 0610 Anhui ADW | IXPV | 1 | Anhui | 4 |
| | | | Aidwen | |
| Alveo (PO) T960 | IXPO | 1.5 | Alveo | 4 |
| Xiangyuan IXPP 10010 | IXPP | 1.5 | Hubei | 4 |

The test results reveal that strong bonding strength is obtained by foam layers applied to the substrate comprising PVC directly after extrusion, without any adhesive. Strong bonding strength is obtained by foam layers comprising vinyl as monomer, such as for the IXPV foam layer. Strong bonding strength is also obtained by foam layers comprising PP, such as PP foam layers and IXPP foam layers, and by foam layer comprising polyolefin, such as the foam layer comprising IXPO.

### Foam Adhesion: PP Substrate

A PP compound was extruded to a strip. The PP compound was FPO® PP Compound 419 from RKW Group. The PP compound is a PP based compound highly filled with talc.

A foam layer was pressed to the extruded strip after extrusion. The foam layer was applied on a surface of the extruded strip directly after the strip had left the die of the extruder. The surface of the extruded strip had a temperature of 200° C. when the foam layer was applied on the surface.

Adhesion strength between the substrate formed by the extruded strip and the foam layer was assessed by separating the substrate and the foam layer by hand. Adhesion strength was graded by the following relative scale: 0: No bond at all; 1: Very poor bond; 2: Poor bond; 3 Good bond; 4: Strong bond; 5: Very strong bond.

Test results according to table 2 below.

TABLE 2

| | Thermo- | | | |
|---|---|---|---|---|
| | plastic | Thickness | | Adhesion |
| Foam layer | polymer | (mm) | Producer | strength |
| Topstar IXPP 1015 | PP | 1.5 | Topstar | 4 |
| Topstar IXPP 1010 | PP | 1 | Topstar | 4 |
| Soft silence | EVA | 1.5 | Shaw | 0 |
| Selit Bloc Griptech | XPS | 1.5 | Sekut | 2 |
| IXPV 0610 Anhui ADW | IXPV | 1 | Anhui | 3 |
| | | | Aidwen | |
| Alveo (PO) T960 | IXPO | 1.5 | Alveo | 4 |
| Xiangyuan IXPP 10010 | IXPP | 1.5 | Hubei | 3 |

The test results reveal that strong bonding strength is obtained by foam layers applied to the substrate comprising PP directly after extrusion, without any adhesive, when the foam layer comprising the same monomer or similar monomer. Strong bonding is obtained by foam layers comprising propylene, such as PP foam layers, and by foam layer comprising polyolefin, such as the foam layer comprising IXPO. Good bonding is obtained by foam layers comprising propylene such as IXPP foam layer, and by IXPV foam layer.

### Items

1. A method to produce a substrate (2) provided with a foam layer (3), comprising
   extruding a substrate (2) comprising a thermoplastic polymer,
   applying a foam layer (3) on a first surface (2a) of the substrate (2) after the substrate (2) has been extruded, the foam layer (3) having a foamed structure and comprising a thermoplastic polymer,
   wherein the foam layer (3) is adhered to the substrate (2) at least partly by heat from the extruded substrate (2).
2. The method according to items 1, wherein the thermoplastic polymer of the foam layer (3) and the thermoplastic polymer of the substrate (2) comprise the same type of thermoplastic polymer.
3. The method according to item 1 or 2, wherein no adhesive is applied to adhere the foam layer (3) to the substrate (2).
4. The method according to any one of the preceding items, wherein the foam layer (3) is applied on the first surface (2a) of the substrate (2) prior to cooling the substrate (2) after extruding.
5. The method according to any one of the preceding items, wherein the foam layer (3) is applied on the first surface (2a) of the substrate (2) when the first surface (2a) of the substrate (2) has a temperature of 120-240° C. after extrusion.
6. The method according to any one of the preceding items, wherein no heat is added when adhering the foam layer (3) to the first surface (2a) of the substrate (2).
7. The method according to any one of the preceding items, wherein the foam layer (3) is applied to the first surface (2a) of the substrate (2) within 10 minutes after the substrate (2) has left the die.
8. The method according to any one of the preceding items, wherein the foam layer (3) is adhered to the substrate as a continuous sheet.
9. The method according to any one of the preceding items, wherein the substrate (2) is in continuous form when the foam layer (3) is adhered to the substrate (2).
10. The method according to any one of the preceding items, wherein the foam layer (3) is applied to the substrate by pressing rollers (21, 22, 23, 23, 24; 31, 32, 33, 34, 35, 36; 41, 42).
11. The method according to any one of the preceding items, wherein the foam layer is applied to the substrate by pressing plates (43, 44).
12. The method according to any one of the preceding items, wherein the thermoplastic polymer of the substrate (2) and of the foam layer (3) is polyvinyl chloride (PVC).
13. The method according to any one of items 1-11, wherein the thermoplastic polymer of the substrate (2) and of the foam layer (3) is polypropylene (PP).
14. The method according to any one of the preceding items, wherein the substrate (2) comprises at least one filler.
15. The method according to any one of the preceding items, wherein the foam layer has a density of less than 700 kg/m³.
16. The method according to any one of the preceding items, wherein the substrate (2) has a density of 800-2200 kg/m³.
17. The method according to any one of the preceding items, wherein the foam layer (3) has a compressive strength about 50-900 kPa (at 0.5 mm) as measured in accordance with EN16354:2018.
18. The method according to any one of the preceding items, further comprising applying a décor layer (4) on a second surface (2b) of the substrate (2) opposite the foam layer (3).
19. A building panel (100), comprising
   an extruded substrate (2) comprising a thermoplastic polymer
   a foam layer (3) having a foamed structure and comprising a thermoplastic polymer, wherein the foamed layer (3) is adhered to a first surface (2a) of the substrate (2) without any adhesive, and
   wherein the foam layer (3) and the substrate (2) comprise the same type of thermoplastic polymer.
20. The building panel according to item 19, wherein the foam layer (3) is adhered to the first surface (2a) of the substrate (2) as a sheet.
21. The building panel according to item 19 or 20, wherein a density of the foam layer (3) is less than a density of the extruded substrate (2).
22. The building panel according to any one of items 19-21, wherein the foam layer (3) has a density of less than 700 kg/m³.
23. The building panel according to any one of items 19-22, wherein the substrate (2) has a density of 800-2200 kg/m³.
24. The building panel according to any one of items 19-23, wherein the thermoplastic polymer of the substrate (2) and of the foam layer (3) is polyvinyl chloride (PVC).
25. The building panel according to any one of items 19-23, wherein the thermoplastic polymer of the substrate (2) and of the foam layer (3) is polypropylene (PP).
26. The building panel according to any one of items 19-25, wherein the substrate (2) comprises at least one filler.
27. The building panel according to any one of items 19-26, wherein the foam layer (3) has a compressive strength about 50-900 kPa (at 0.5 mm) as measured in accordance with EN16354:2018.
28. The building panel according to any one of items 19-27, further comprising a surface layer (4) on a second surface (2b) of the substrate (2) opposite the foam layer (3).
29. A method to produce a panel (100) or a substrate element (10), optionally configured for flooring, comprising a substrate (2) provided with a foam layer (3), the method comprising
   extruding, in an extrusion process, a substrate (2) comprising a thermoplastic polymer,
   applying a foam layer (3) on a first surface (2a) of the substrate (2) after the substrate (2) has been extruded, the foam layer (3) having a foamed structure and comprising a thermoplastic polymer, wherein a density of the foam layer (3) is less than the density of the substrate (2), and a thickness of the foam layer (3) is less than a thickness of the substrate (2),
   wherein the foam layer (3) is adhered to the substrate (2) at least partly by heat from the extruded substrate (2), wherein the heat from the extruded substrate (2) originates from the extrusion process,
   applying a surface layer (4) on a second surface (2b) of the substrate (2), opposite the foam layer (3), wherein the surface layer (4) comprises a decorative layer (4a).
30. The method according to item 29, wherein the substrate (2) has a density of 800-2200 kg/m³.
31. The method according to item 29 or 30, wherein the substrate (2) has a thickness of 3-12 mm, such as 4-8 mm.
32. The method according to any one of items 29-31, wherein the foam layer (2) has a thickness of 0.25-5 mm, such as 0.5-3 mm.
33. The method according to any one of items 29-32, wherein the thermoplastic polymer of the foam layer (3) and the thermoplastic polymer of the substrate (2) comprise comprising the same monomer.
34. The method according to any one of items 29-33, wherein no adhesive is applied to adhere the foam layer (3) to the substrate (2).
35. The method according to any one of items 29-34, wherein the foam layer (3) is applied on the first surface (2a) of the substrate (2) when the first surface (2a) of the substrate (2) has a temperature of 120-240° C. after extrusion.
36. The method according to any one of items 29-35, wherein no heat is added after the extrusion process for adhering the foam layer (3) to the first surface (2a) of the substrate (2).
37. The method according to any one of items 29-36, wherein the foam layer (3) is applied to the first surface (2a) of the substrate (2) within 10 minutes after the substrate (2) has left an extrusion die.
38. The method according to any one of items 29-37, wherein the foam layer (3) is adhered to the substrate as a continuous sheet.
39. The method according to any one of items 29-38, wherein the substrate (2) is in continuous form when the foam layer (3) is adhered to the substrate (2).
40. The method according to any one of items 29-39, wherein the foam layer (3) is applied to the substrate by pressing rollers (21, 22, 23, 23, 24; 31, 32, 33, 34, 35, 36; 41, 42).
41. The method according to any one of items 29-40, wherein the surface layer (4) is applied to the substrate (2) by pressing rollers (41, 42).
42. The method according to any one of items 29-41, wherein the thermoplastic polymer of the substrate (2) and of the foam layer (3) is polyvinyl chloride (PVC).
43. The method according to any one of items 29-42, wherein the thermoplastic polymer of the substrate (2) and of the foam layer (3) is polypropylene (PP).
44. The method according to any one of items 29-43, wherein the substrate (2) comprises at least one filler.
45. The method according to any one of items 29-44, wherein the foam layer has a density of less than 700 kg/m³.
46. The method according to any one of items 29-45, wherein the foam layer (3) has a compressive strength about 50-900 kPa (at 0.5 mm) as measured in accordance with EN16354:2018.
47. The method according to any one of items 29-46, wherein the decorative layer (4a) is a printed polymeric film.
48. The method according to any one of items 29-47, wherein the surface layer (4) further comprises a wear layer (4b).
49. The method according to any one of items 29-48, further comprising dividing the substrate element (10) into panels (100).
50. A panel (100), such as a floor panel, comprising
   an extruded substrate (2) comprising a thermoplastic polymer,
   a foam layer (3) having a foamed structure and comprising a thermoplastic polymer, wherein a density of the foam layer (3) is less than the density of the substrate (2) and a thickness of the foam layer (3) is less than a thickness of the substrate (2),
   wherein the foamed layer (3) is adhered to a first surface (2a) of the substrate (2) without any adhesive, and
a surface layer (4) on a second surface (2b) of the substrate (2), opposite the foam layer (3), wherein the surface layer (4) comprises a decorative layer (4a).
51. The panel according to item 50, wherein the thermoplastic polymer of the foam layer (3) and the thermoplastic polymer of the substrate (2) comprise the same monomer.
52. The panel according to item 50 or 51, wherein the extruded substrate (2) has a density of 800-2200 kg/m³.
53. The panel according to any one of items 50-52, wherein the substrate (2) has a thickness of 3-12 mm, such as 4-8 mm.
54. The panel according to any one of items 50-53, wherein the foam layer (2) has a thickness of 0.25-5 mm, such as 0.5-3 mm.
55. The panel according to any one of items 50-54, wherein the foam layer (3) is adhered to the first surface (2a) of the substrate (2) as a sheet.
56. The panel according to any one of items 50-55, wherein the foam layer (3) has a density of less than 700 kg/m³.
57. The panel according to any one of items 50-56, wherein the thermoplastic polymer of the substrate (2) and of the foam layer (3) is polyvinyl chloride (PVC).
58. The panel according to any one of items 50-57, wherein the thermoplastic polymer of the substrate (2) and of the foam layer (3) is polypropylene (PP).
59. The panel according to any one of items 50-58, wherein the substrate (2) comprises at least one filler.
60. The panel according to any one of items 50-59, wherein the foam layer (3) has a compressive strength about 50-900 kPa (at 0.5 mm) as measured in accordance with EN16354:2018.
61. The panel according to any one of items 50-60, wherein the decorative layer (4a) is a printed polymeric film.
62. The panel according to any one of items 50-61, wherein the surface layer (4) further comprises a wear layer (4b).

1. A method to produce a panel or a substrate element for flooring, comprising a substrate provided with a foam layer, the method comprising
extruding, in an extrusion process, a substrate comprising a thermoplastic polymer and having a density of 800-2200 kg/m³,
applying a foam layer on a first surface of the substrate after the substrate has been extruded, the foam layer having a foamed structure and comprising a thermoplastic polymer, wherein a density of the foam layer is less than the density of the substrate, and a thickness of the foam layer is less than a thickness of the substrate,
wherein the foam layer is adhered to the substrate at least partly by heat from the extruded substrate, wherein the heat from the extruded substrate originates from the extrusion process,
applying a surface layer on a second surface of the substrate, opposite the foam layer, wherein the surface layer comprises a decorative layer.

2. The method according to claim 1, wherein the substrate has a thickness of 3-12 mm.

3. The method according to claim 1, wherein the foam layer has a thickness of 0.25-5 mm.

4. The method according to claim 1, wherein the thermoplastic polymer of the foam layer and the thermoplastic polymer of the substrate comprise comprising the same monomer.

5. The method according to claim 1, wherein no adhesive is applied to adhere the foam layer to the substrate.

6. The method according to claim 1, wherein the foam layer is applied on the first surface of the substrate when the first surface of the substrate has a temperature of 120-240° C. after extrusion.

7. The method according to claim 1, wherein no heat is added after the extrusion process for adhering the foam layer to the first surface of the substrate.

8. The method according to claim 1, wherein the foam layer is adhered to the substrate as a continuous sheet.

9. The method according to claim 1, wherein the substrate is in continuous form when the foam layer is adhered to the substrate.

10. The method according to claim 1, wherein the foam layer is applied to the substrate by pressing rollers.

11. The method according to claim 1, wherein the thermoplastic polymer of the substrate and of the foam layer is polyvinyl chloride.

12. The method according to claim 1, wherein the thermoplastic polymer of the substrate and of the foam layer is polypropylene.

13. The method according to claim 1, wherein the substrate comprises at least one filler.

14. The method according to claim 1, wherein the foam layer has a compressive strength about 50-900 kPa (at 0.5 mm) as measured in accordance with EN16354:2018.

15. The method according to claim 1, wherein the decorative layer is a printed polymeric film.

16. The method according to claim 1, further comprising dividing the substrate element into panels.

17. A floor panel, comprising
an extruded substrate comprising a thermoplastic polymer and having a density of 800-2200 kg/m³,
a foam layer having a foamed structure and comprising a thermoplastic polymer, wherein a density of the foam layer is less than the density of the substrate and a thickness of the foam layer is less than a thickness of the substrate,
wherein the foamed layer is adhered to a first surface of the substrate without any adhesive,
wherein the thermoplastic polymer of the foam layer and the thermoplastic polymer of the substrate comprise the same monomer, and
a surface layer on a second surface of the substrate, opposite the foam layer, wherein the surface layer comprises a decorative layer.

18. The floor panel according to claim 17, wherein the thermoplastic polymer of the substrate and of the foam layer is polyvinyl chloride.

19. The floor panel according to claim 17, wherein the thermoplastic polymer of the substrate and of the foam layer is polypropylene.

20. The floor panel according to claim 17, wherein the substrate comprises at least one filler.

21. The floor panel according to claim 17, wherein the foam layer has a compressive strength about 50-900 kPa (at 0.5 mm) as measured in accordance with EN16354:2018.
